(19) United States
(12) Patent Application Publication
(10) Pub. No.: US 2002/0122838 A1
(43) Pub. Date: Sep. 5, 2002

(54) Blow molding method and system

(76) Inventors: Jere R. Anderson, Newburyport, MA (US); Kent G. Blizard, Ashland, MA (US); Douglas Zeik, Middleton, OH (US)

Correspondence Address: Timothy J. Oyer, Wolf, Greenfield & Sacks, P.C., 600 Atlantic Avenue, Boston, MA, 02210, US

(21) Appl. No.: 09/755,006

(22) Filed: Jan. 4, 2001

(51) Int. Cl. B29C 49/78

(52) U.S. Cl. 425/149; 264/523; 264/529; 264/571; 425/532

(57) ABSTRACT

The invention provides blow molding methods and systems for polymer processing. The methods involve blow molding a parison of polymeric material using a variable blow pressure. The pressure is varied to produce high quality blow molded articles which may be formed of solid polymer or polymeric foam including microcellular material. In particular, foam articles can be produced at relatively low densities and/or with good definition. The blow molding systems and methods may be used to produce a variety of different types of articles including bottles, containers, cases, automotive parts, toys and panels.

### FIELD OF INVENTION

The invention relates generally to polymer processing and, more particularly, to a blow molding method and system.

### BACKGROUND OF INVENTION

Polymeric materials may be processed using a number of conventional techniques including blow molding. In a typical blow molding process, a parison (an essentially cylindrical polymeric sleeve) is extruded and positioned within a mold, while still hot enough to be moldable. Pressurized gas may be introduced into the interior of the parison which causes it to expand against walls of the mold. A variety of articles may be produced using blow molding techniques including bottles, containers, cases, automotive parts, toys and panels.

Polymeric foam materials may also be processed using blow molding techniques. Polymeric foams include a plurality of cells (or voids) formed within a polymer matrix. Microcellular foams (or microcellular materials) are polymeric foams which have very small cell sizes and high cell densities. By replacing solid plastic with voids, polymeric foams use less raw material than solid plastics for a given volume. Thus, raw material savings increase as the density of a foam decreases.

The pressure of the gas used to inflate the parison during blow molding is commonly referred to as blow pressure. To achieve good product definition, particularly in designs that contain deep textured surfaces or sharp corners, relatively high blow pressures (e.g., greater than 50 psi) typically are used. However, using high pressures to blow mold polymeric foam parisons can cause compression of the cell structure which increases foam density. Consequently, achievable density reductions using blow molded foam products may be limited, particularly, when good product definition is required. In other cases, high blow pressures may cause a foam parison to rupture.

Accordingly, a blow molding process and system that enables production of high quality blow molded foam articles at relatively low densities is desirable.

### SUMMARY OF INVENTION

The invention provides blow molding methods and systems for polymer processing. The methods involve blow molding a parison of polymeric material using a variable blow pressure. The pressure is varied to produce high quality blow molded articles which may be formed of solid polymer or polymeric foam including microcellular material. In particular, foam articles can be produced at relatively low densities and/or with good definition. The blow molding systems and methods may be used to produce a variety of different types of articles including bottles, containers, cases, automotive parts, toys and panels.

In one aspect, the invention provides a method of blow molding. In one embodiment, the method includes the step of blow molding a foam parison using variable pressure.

In another embodiment, the method includes the steps of positioning a foam parison in a mold, introducing a gas into the foam parison in the mold at a first pressure, and changing the pressure of the gas introduced into the parison to a second pressure greater than atmospheric pressure.

In another embodiment, the method includes the step of blow molding a polymeric parison using a pressure within a first pressure range, followed by a pressure within a second pressure range, followed by a pressure within a third pressure range.

In another aspect, the invention provides a blow molding system. The blow molding system includes a polymer processing apparatus constructed and arranged to release polymeric material through an outlet of the polymer processing apparatus in the form of a parison. The molding system further includes a mold positioned to receive the parison. The molding system further includes a pressure supply associated with the mold and capable of applying a variable blow pressure to the parison in the mold, and a controller coupled to the pressure supply and designed to control the variable pressure applied by the pressure supply.

Other advantages, aspects, and features of the invention will become apparent from the following detailed description of the invention when considered in conjunction with the accompanying drawings.

### BRIEF DESCRIPTION OF THE DRAWINGS

FIGS. 1A and 1B schematically illustrate a blow molding system according to one embodiment of the present invention at different stages during a blow molding cycle.

FIGS. 2A-2G schematically illustrate exemplary blow pressure profiles which may be used in accordance with the methods of the present invention.

FIG. 3 schematically illustrates a pressure supply according to one embodiment of the present invention.

FIG. 4 shows a series of photos of blow molded bottles produced using different processing conditions according to methods of the present invention.

### DETAILED DESCRIPTION OF INVENTION

The invention provides methods and systems for blow molding polymeric materials. The methods utilize a variable pressure blow cycle to blow mold articles. The pressure may be varied, as described further below, to form articles having desired characteristics such as reduced densities and good definition. The methods may be used to form solid polymer articles or polymeric foam articles including microcellular material articles.

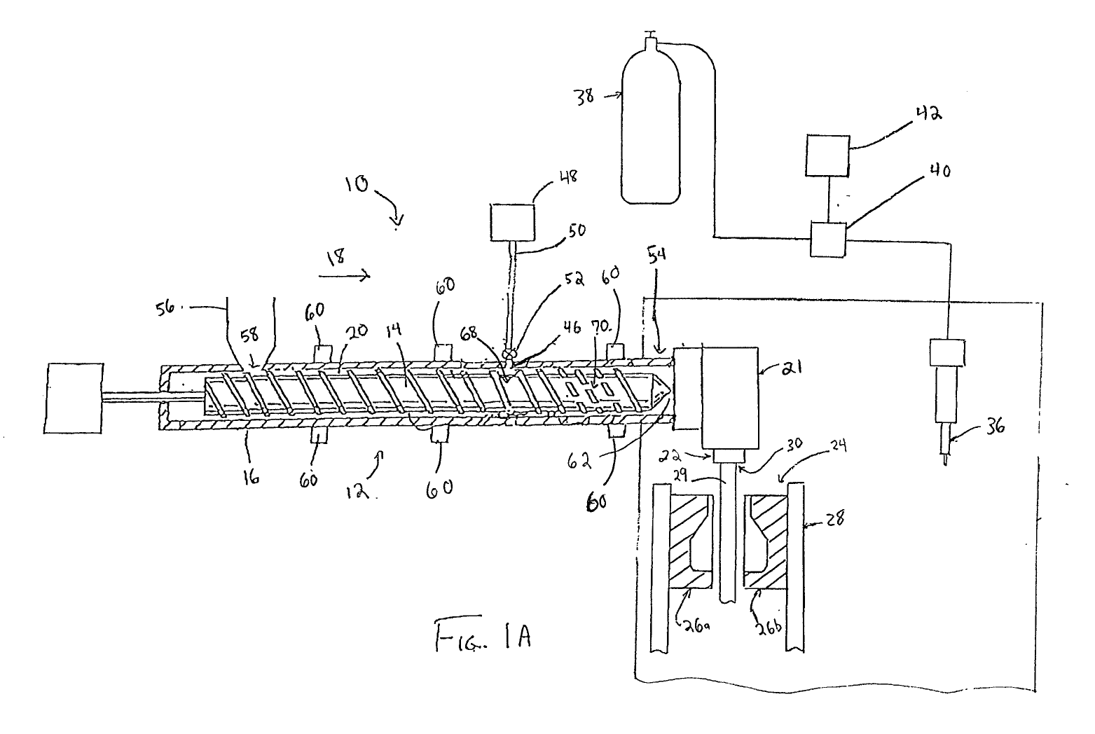

Referring to FIGS. 1A and 1B, a blow molding system 10 according to one embodiment of the invention is schematically shown. An extruder 12 of blow molding system 10 includes a polymer processing screw 14 that is rotatable within a barrel 16 to convey polymeric material in a downstream direction 18 within a polymer processing space 20 defined between the screw and the barrel. A head 21 is attached to a downstream end of the extruder which includes a die 22 fixed to an outlet end of the head. System 10 includes a blow mold 24 having a first mold half 26a and a second mold half 26b which may be opened and closed, for example, by the movement of a press 28. In a first position (FIG. 1A), blow mold 24 is in an open configuration and is positioned to receive a parison 29 released from an outlet 30 of die 22. After receiving the parison, the blow mold closes to capture the parison in a mold cavity 32 and moves to a position under a blow pin 36 (FIG. 1B) thereby separating the parison from the die. Blow pin 36 injects a gas provided by a gas supply 38 into the parison. The gas provides an internal pressure (e.g., blow pressure) that forces the parison against the walls of the mold, thereby molding the article. As described further below, the blow pressure may be varied by a pressure supply 40 connected to blow pin 36 and, optionally, a controller 42 to produce articles having the desired characteristics. The molded parison is cooled within mold cavity 32 for a sufficient time, after which mold halves 26a, 26b separate to open cavity 32 to produce a blow molded article.

In the embodiment of FIGS. 1A and 1B, a blowing agent port 46 is formed in barrel 16 and is connected to a blowing agent source 48 using conduit 50. If desired, blowing agent from the source may be introduced into polymeric material within the polymer processing space via the blowing agent port during polymer foam processing, as described further below. A shut-off valve 52 may be associated with the blowing agent port to control the introduction of blowing agent into the polymeric material. Other embodiments which do not utilize physical blowing agents may not include any of the following: blowing agent port 46, blowing agent source 48, conduit 50 and shut-off valve 52.

In one embodiment, blow molding system 10 operates cyclically to produce a series of blow molded articles using a reciprocating screw method for forming the parison. However, it should be understood that any technique for forming the parison may be utilized (continuous or discontinuous) in combination with a variety of molding methods including continuous wheel, shuttle, and accumulator head techniques.

Using the reciprocating screw technique for forming the parison, screw 14 is positioned at a downstream end 54 of barrel 16 at the beginning of a blow molding cycle. Polymeric material, typically in pelletized form, is fed into polymer processing space 20 from a hopper 56 through an orifice 58. Screw 14 rotates to plasticate polymeric material and to convey the polymeric material in downstream direction 18. A fluid stream of polymeric material is produced within the polymer processing space as a result of the screw rotation and heat which maybe provided by one or more heating units 60 arranged in suitable positions external of the barrel.

If desired, blowing agent is introduced into the polymeric melt from blowing agent source 48 through blowing agent port 46 to form a mixture of blowing agent and polymeric material in processing space 20. The mixture is conveyed downstream by the rotating screw and accumulated in a region 62 within the barrel downstream of the screw. The accumulation of the mixture in region 62 creates a pressure that forces the screw axially in an upstream direction in the barrel. After a sufficient charge of the mixture has been accumulated, screw 14 ceases to rotate and stops moving in the upstream direction. In some cases, when the screw no longer plasticates polymeric material the flow of blowing agent into the polymeric material may be stopped, for example, by the operation of shut-off valve 52 associated with the blowing agent port.

Then, the screw is moved axially to downstream end 54 of the barrel to eject the accumulated charge of the mixture through die 22 and into blow mold 24. Die 22 is typically is opened to permit the mixture to flow through outlet 30. As described above, the mixture is extruded in the form of a foam parison which is received by blow mold 24 (FIG. 1A) and moved to a position under blow pin 36 (FIG. 1B) which inflates the parison using a variable pressure thereby forcing it against the walls of mold cavity 32. The blow pressure is maintained, as described further below, as the parison cools to form the molded article. As used herein, the blow cycle refers to the time over which the pressure is maintained within the parison. The method can be repeated to produce additional blow molded articles.

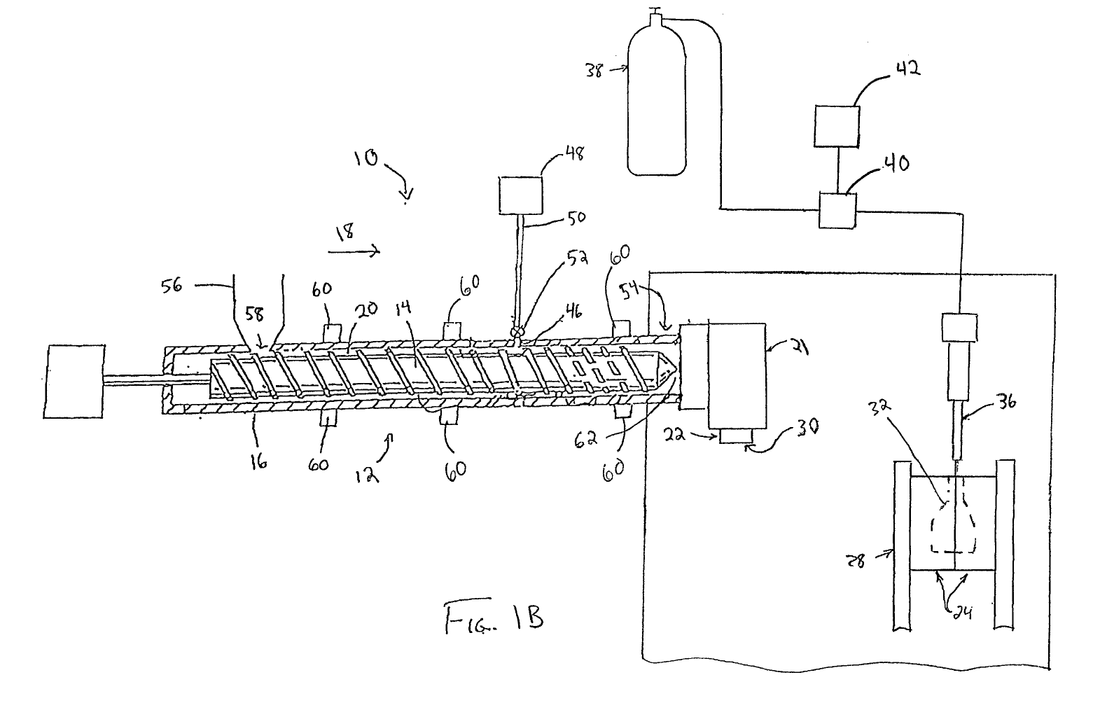

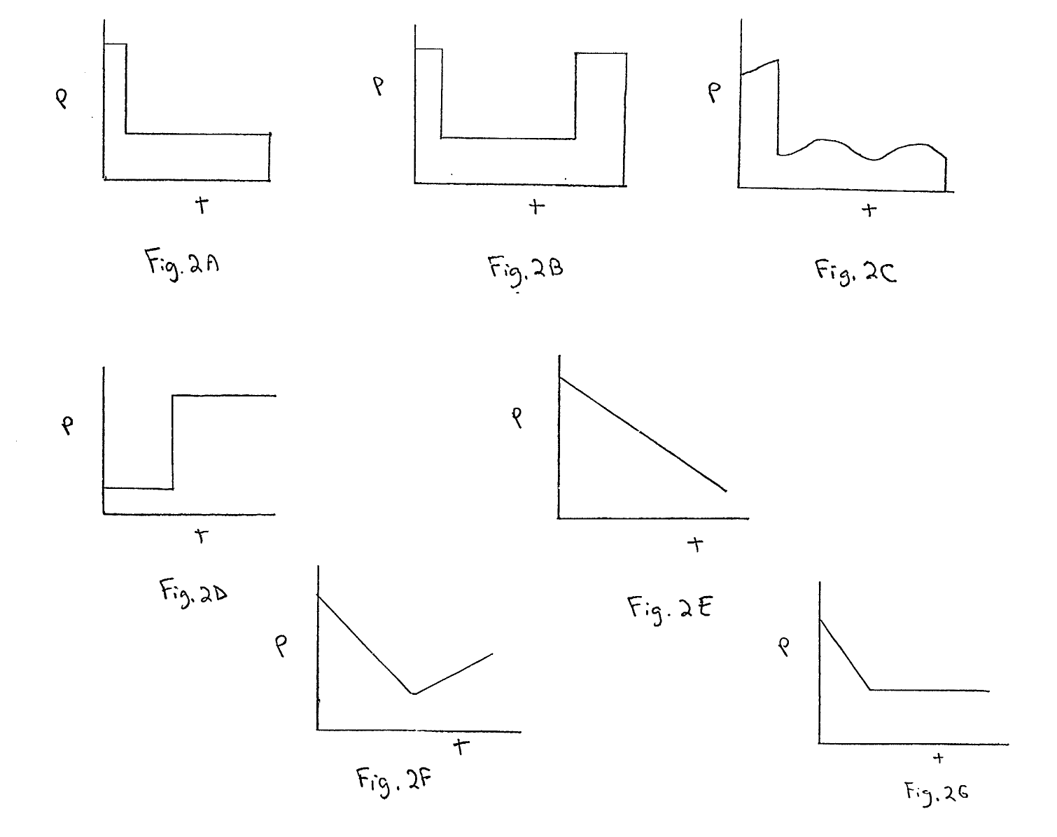

As described above, the method of the invention utilizes a blow pressure that is varied during the blow cycle. The pressure may be varied to produce blow molded articles having desired characteristics. The blow pressure profile (e.g., the variation of pressure over time during the blow cycle), therefore, depends upon the particular process. Exemplary pressure profiles, which are not intended to be limiting, are illustrated in FIGS. 2A-2G and described further below.

In one set of embodiments, the blow pressure may include a stepped pressure profile as shown in FIG. 2A. In these embodiments, the blow pressure profile may include two or more pressure ranges. For example, the blow cycle may utilize a first pressure that is applied within a first pressure range, followed by a second pressure that is applied within a second pressure range.

In certain methods, it may be advantageous to utilize a relatively high first pressure followed by a relatively low second pressure. The relatively high first pressure may be greater than about 25 psi; in some cases, greater than about 50 psi; and, in some cases, greater than about 75 psi. The relatively low second pressure may be less than about 20 psi and, in some cases, between about 10 psi and about 20 psi. Certain methods of the invention apply the relatively high first pressure for a short time duration (e.g., less than 25 percent of the time period of the blow cycle) and apply the relatively low second pressure for a longer time duration (e.g., greater than 25 percent of the time period of the blow cycle). In some cases, the relatively high first pressure is applied for very short time durations such as less than 10 percent, less than 5 percent, or even less than 1 percent of the total blow cycle. Blow pressure profiles having a relatively high pressure for a short time duration, followed by a relatively low pressure for a longer time duration have been particularly useful in producing relatively low-density foam articles having good definition. It is believed that the high first pressure rapidly forces the parison against the mold walls which causes the parison to be cooled quickly. The quick cooling promotes expansion of cells within the foam which reduces foam density. The lower second pressure maintains sufficient contact between the foam parison and the walls to ensure good definition, but does not overly compress the foam structure to cause a significant increase in foam density.

In some methods, it may be useful to utilize a blow pressure profile that includes a third pressure range as shown in FIG. 2B. For example, certain methods may apply a pressure within a third pressure range after applying a relatively high first pressure applied for a short time duration and a relatively low pressure applied for a longer time duration. In such methods, the third pressure range may be greater than the second pressure range. The third pressure range, for example, may be greater than 40 psi; in some cases, greater than 60 psi, and in some cases greater than 80 psi. The pressure within the third range may be applied, for example, for a time period of greater than 25 percent of the time period of the blow cycle. Applying a relatively high third (and final) pressure may improve the definition of the blow molded article without increasing density.

It should be understood that any variable blow pressure profile may be used according to the methods of the invention. In some cases, the second blow pressure may be relatively high (e.g., less than about 50 psi). In the embodiments described above in which different pressure ranges are used during the blow cycle, any pressure may be applied within the respective range. For example, in some cases, a constant blow pressure within the respective ranges may be applied (FIG. 2A). In other cases, the blow pressure may vary within the respective ranges (FIG. 2C). Blow cycles that utilize a relatively low first pressure followed by a relatively high second pressure may also be used (FIG. 2D). Blow cycles that utilize more than three pressure ranges may be used. When stepped blow pressure profiles are utilized, it should be understood that the change in blow pressure between respective ranges may not be instantaneous. Thus, a short time interval can exist over which the transition between the two pressure ranges occurs. The length of the time interval depends, in part, upon the response time of the system. Some methods of the present invention may not utilize a stepped blow pressure profile. For example, the blow pressure may be varied continuously throughout the blow cycle (FIGS. 2E and 2F). In other cases, the blow pressure may be varied continuously for only a portion of the cycle (FIG. 2G). The most appropriate pressure profile depends upon the requirements of the blow molding process and may be determined by experimentation.

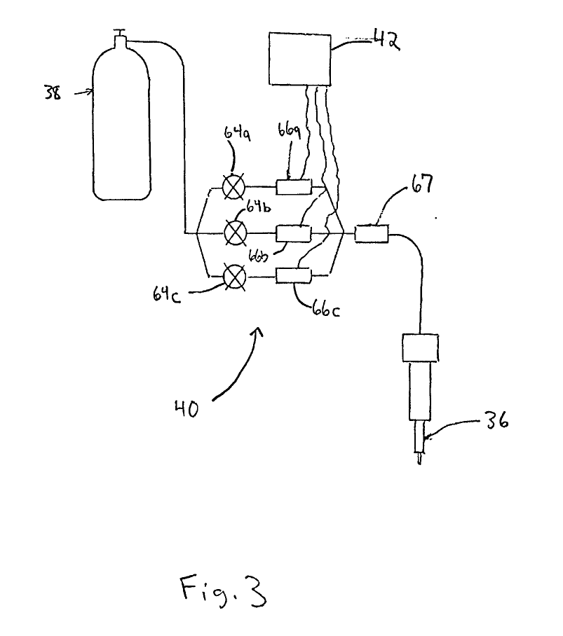

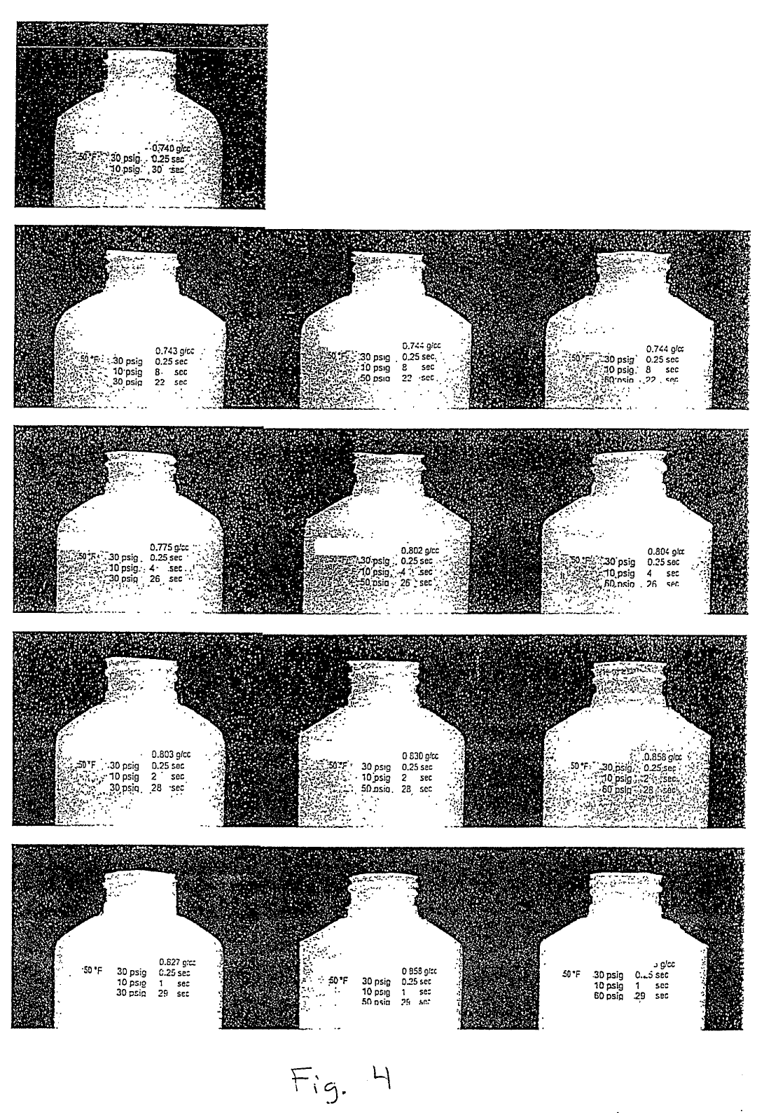

Referring to FIG. 3, one embodiment of pressure supply 40 is shown schematically. The illustrative pressure supply may be used to provide a blow cycle having three pressure stages. Pressure supply 40 includes multiple pressure regulators 64a, 64b, 64c arranged in parallel. The pressure regulators, for example, may be designed to provide respective blow pressures. Each pressure regulator 64a, 64b, 64c is associated with a valve 66a, 66b, 66c which controls flow of the gas from the respective pressure regulators. Each valve 66a, 66b, 66c is independently connected to controller 42. Valves 66a, 66b, 66c are electronically actuated by signals from controller 42 at appropriate times during the blow cycle to provide the desired blow pressure. An air relief valve 67 may also be provided which vents excess pressure as the valves are actuated at the varying pressures preset by the regulators.

During one typical method for providing a blow cycle having three pressure stages, valve 66a is opened by controller 42 (while valves 66b, 66c are closed) to provide the first pressure in the blow cycle set by pressure regulator 64a. During the second stage, valve 66b is opened by controller 42 (while valves 66a, 66c are closed) to provide the second pressure in the blow cycle set by pressure regulator 64b. During the third stage, valve 66c is opened by controller 42 (while valves 66a, 66b are closed) to provide the third pressure in the blow cycle set by pressure regulator 64c.

It should be understood that pressure supply 40 may have any design capable of providing a suitable pressure and volume of gas. Alternative arrangements of regulators and/or valves than the arrangement shown in FIG. 3 may be used. For example, a single, proportioning regulator that is capable of varying pressure in response to signals from controller 42 may be used. When two stage blow pressure methods are utilized, two valves and two regulators may be used. In some cases, pressure supply 40 and gas supply 38 may be combined in a single unit such as a gas cylinder or air compressor.

Controller 42 may be any of the type known in the art capable of controlling the blow pressure during the blow cycle. Suitable controllers include, but are not limited to, computers, PLCs, and timers. In some embodiments, a controller is not required and other techniques may be used to vary the blow pressure.

It is to be understood that the blow molding system of FIGS. 1A and 1B may be modified for a specific process in any way known to those of ordinary skill in the art. For example, the system may be modified so that the parison is formed using continuous extrusion techniques. Also, the system may be modified to include an accumulator external of the barrel in which the charge that forms the parison is accumulated. The system may also be modified so that the parison is injection-molded utilizing shuttle, fixed press, or wheel techniques. In some embodiments, the variable blow pressure may be used in combination with the techniques of using a negative pressure around the exterior of the parison within the blow mold. In some cases, the negative pressure may be varied in any manner described herein to blow mold the article according to methods of the present invention. In some of these cases, the positive blow pressure provided by the blow pin may be eliminated in lieu of the varying negative pressure.

Any suitable blow molding system may be utilized in accordance with the present invention that is capable of applying a variable blow pressure. Thus, conventional blow molding systems may be used in accordance with the invention, if modified accordingly to provide a variable blow pressure. For example, one blow molding system that may be suitably modified is the system described in U.S. patent application Ser. No. 09/241,352, filed Feb. 2, 1999, which is incorporated herein by reference.

As described above, a physical blowing agent may be introduced into the polymeric material in the extruder when producing polymeric foam blow molded articles. In other cases, the methods of the invention may utilize chemical blowing agents to produce polymeric foam blow molded articles. It should also be understood that the methods and systems of the invention can be used to produce solid polymeric blow molded articles. When chemical blowing agents are utilized or when solid polymeric blow molded articles are produced, blow molding system 10 may be modified accordingly.

When chemical blowing agents are utilized, the chemical blowing agents may be any of the type known in the art. The chemical blowing agents may be pre-mixed with the polymeric material prior to introduction into the extruder, or may be introduced into the polymeric material within polymer processing space 20. Generally, the amount of chemical blowing agent is less than about 5 weight percent of the mixture of polymeric material and chemical blowing agent, though the exact amount depends upon the particular process.

When utilized, physical blowing agents may be any suitable composition known in the art including nitrogen, carbon dioxide, hydrocarbons, chlorofluorocarbons, noble gases and the like, or mixtures thereof. The blowing agent may be introduced into the polymeric material in any flowable state, for example, a gas, liquid, or supercritical fluid. In some cases, it may be preferable that the blowing agent is in a supercritical state once introduced into the polymeric material in the extruder. That is, the blowing agent is a supercritical fluid under the temperature and pressure conditions within the extruder. According to one preferred embodiment, the blowing agent is carbon dioxide. In another preferred embodiment the blowing agent is nitrogen. In certain embodiments, the blowing agent is solely carbon dioxide or nitrogen. Blowing agent may be introduced into the polymeric material to provide a mixture having the desired weight percentage for a particular process. The weight percentage of physical blowing agent may depend upon a number of variables including the desired density of the blow molded polymeric material. When physical blowing agents are used, the blowing agent percentage is typically less than about 15% by weight of the mixture of polymeric material and blowing agent. In some embodiments, the physical blowing agent level is less than about 8% and in some embodiments less than about 5%. In some cases, it may be preferable to use low weight percentages of physical blowing agent. For example, the physical blowing agent level may be less than about 3%, in others less than about 1% and still others less than about 0.1% by weight of polymeric material and blowing agent mixture. The physical blowing agent weight percentage may also depend upon the composition of blowing agent used.

The physical blowing agent introduction rate may be coupled to the flow rate of polymeric material to produce a mixture having the desired weight percentage of blowing agent. Blowing agent may be introduced into the polymeric material over a wide range of flow rates. In some embodiments, the blowing agent mass flow rate into the polymeric material may be between about 0.001 lbs/hr and about 100 lbs/hr, in some cases between about 0.002 lbs/hr and about 60 lbs/hr, and in some cases between about 0.02 lbs/hr and about 10 lbs/hr. As described above, in some processes which discontinuously plasticate polymeric material, it may be preferable to stop the introduction of blowing agent into the polymeric material (e.g., using shut-off valve 52) when plasticating ceases.

In some embodiments, in which a physical blowing agent is used, it may be preferable to form a single-phase solution of polymeric material and blowing agent within polymer processing space 20 and to maintain the single-phase condition until the solution is ejected through the die. Single-phase solution formation may be particularly useful when the blow molded article is a microcellular material which are described further below. It should be understood that in some embodiments, single-phase solution formation is not preferred.

When desired, to aid in the formation of the single-phase solution, blowing agent introduction may be done through a plurality of blowing agent ports 46 arranged in the barrel, though it should be understood that a single port may also be utilized to form a single-phase solution. When multiple ports 46 are utilized, the ports can be arranged radially about the barrel or in a linear fashion along the axial length of the barrel. An arrangement of ports along the length of the barrel can facilitate injection of blowing agent at a relatively constant location relative to the screw when the screw moves axially (in an upstream direction) within the barrel as the mixture of polymeric material and blowing agent is accumulated. Where radially-arranged ports are used, ports 46 may be placed at the 12:00 o'clock, 3:00 o'clock, 6:00 o'clock and 9:00 o'clock positions about the extruder barrel, or in any other configuration as desired. Blowing agent port 46 may include a single orifice or a plurality of orifices. Multiple ports may be provided with multiple orifices associated with each port. In some embodiments, multiple orifices may be provided in a separate assembly which is inserted within a bore in the barrel to define a port having multiple orifices. In the multi-orifice embodiments (not illustrated), the port may include at least about 2, and some cases at least about 4, and others at least about 10, and others at least about 40, and others at least about 100, and others at least about 300, and others at least about 500, and in still others at least about 700 blowing agent orifices. In another embodiment, port 46 includes a porous material that permits blowing agent to flow therethrough and into the barrel, without the need to machine a plurality of individual orifices.

To further promote the formation of a single-phase solution, blowing agent port 46 may be located at a blowing agent injection section 68 of the screw. The blowing agent injection section of the screw may include full, unbroken flight paths. In this manner, each flight, passes or “wipes” the blowing agent port including orifices periodically, when the screw is rotating. This wiping increases rapid mixing of blowing agent and polymeric material in the extruder and the result is a distribution of relatively finely divided, isolated regions of blowing agent in the polymeric material immediately upon injection into the barrel and prior to any mixing. This promotes formation of a uniform polymer and blowing agent mixture which may be desired in certain types of polymeric processing including microcellular processing. Downstream of the blowing agent injection section, the screw may include a mixing section 70 which has highly broken flights to further mix the polymer and blowing agent mixture to promote formation of a single-phase solution.

In some embodiments in which a single-phase solution of polymeric material and blowing agent is formed, it may be preferable to nucleate the solution when ejecting through die 22. Nucleation is achieved via a pressure drop, for example, that occurs when the solution passes through outlet 30 which functions as a nucleating pathway. The nucleated sites in the solution grow into cells within the mold to form a polymeric foam parison. In some cases, the cell nucleation rate and growth may be controlled to form a microcellular polymeric material. Suitable dies, particularly when producing microcellular blow molded materials, have been described in U.S. patent application Ser. No. 09/241,352, referenced above. Particularly, nucleating pathways (e.g. gates) that provide a high pressure drop rate, for example greater than 0.1 GPa/s or higher, may be utilized to form microcellular materials in certain cases. Suitable nucleating pathways have been described, for example, in International Patent Application Serial No. PCT/US97/15088, filed Aug. 26, 1997, which is incorporated herein by reference.

Any polymeric material suitable for forming blow molded articles may be used with the systems and methods of the invention. Such polymeric materials, in some cases, are thermoplastics which may be amorphous, semicrystalline, or crystalline materials. Typical examples of polymeric materials used include styrenic polymers (e.g., polystyrene, ABS), polyolefins (e.g., polyethylene and polypropylene), PVC, polyamides, polyesters, and the like. The polymeric material may be in the form of virgin resin, industrial recycled material, or post-consumer recycled material. The type of polymeric material used depends upon the application.

When the polymeric material is processed using a physical blowing agent (or no blowing agent), the blow molded article is generally free of residual chemical blowing agents or reaction byproducts of chemical blowing agents. In cases where chemical blowing agents are used, the article may include residual chemical blowing agents or reaction byproducts of chemical blowing agents. Optionally, the polymeric material may be processed with a nucleating agent, such as talc or calcium carbonate. In other embodiments, the polymeric material may be free of a nucleating agent. The blow molded article may also include any number of other processing additives known in the art such as lubricants, plasticizers, colorants, fillers and the like.

Any type of blow molded article may be produced using the methods and systems of the present invention. The articles can have a variety of shapes and sizes. Exemplary articles include bottles, containers, cases, automotive parts, toys, and panels.

High quality blow molded articles which have excellent product definition may be produced using the methods and systems of the present invention. The method of the present invention can reduce the crushing of the cell structure while ensuring sufficient contact of the parison with mold surfaces. As a result, foam articles having improved product definition at lower densities (higher void fractions) can be produced using the variable blow pressure method. The particular density (and void fraction) of the foam will depend upon the application. In some embodiments, blow molded articles have a void fraction of greater than about 0.50; in other embodiments, a void fraction of greater than about 0.35; in other embodiments, a void fraction of greater than about 0.15; in other embodiments, a void fraction of greater than about 0.10; and, in other embodiments, a void fraction of greater than about 0.05.

In certain embodiments, microcellular blow molded articles may be produced. Suitable microcellular blow molded materials have been described in U.S. patent application Ser. No. 09/241,352, referenced above. Microcellular foams, or microcellular materials, have small cell sizes and high cell densities which may provide property advantages over non-microcellular foams. As used herein, the term “cell density” is defined as the number of cells per cubic centimeter of original, unexpanded polymeric material. In some embodiments, the microcellular materials are produced having an average cell size of less than about 100 microns; in other embodiments, an average cell size of less than about 75 microns; in other embodiments, an average cell size of less than about 50 microns; in other embodiments, an average cell size of less than about 25 microns; and, in still other embodiments, an average cell size of less than about 10 microns. In some of these microcellular embodiments, the cell size may be uniform, though a minority amount of cells may have a considerably larger or smaller cell size. In some cases, the cells may have a compressed shape (i.e., non-spherical) as a result of the blow molding process. In these cases, the average cell size is determined to be the average dimension of the cell.

In some cases, the microcellular materials have a cell density of greater than about 10⁶ cells/cm³, in others greater than about 10⁷ cells/cm³, in others greater than about 10⁸ cells/cm³, and in others greater than about 10⁹ cells/cm³. The particular cell structure characteristics, including cell size and cell density, depends upon the application.

The function and advantage of these and other embodiments of the present invention will be more fully understood from the examples below. The following examples are intended to illustrate the benefits of the present invention, but do not exemplify the full scope of the invention.

### EXAMPLE 1

### Blow Molding System

This example illustrates a blow molding system according to one embodiment of the present invention. A blow molding system including a Battenfeld-Fischer VK1-5 single station shuttle blow molder modified with a specially designed extrusion system was employed for this bottle development. This machine was designed to provide continuous, high rate extrusion capability with intermittent bottle molding. This configuration allowed complete separation of the extrusion and molding conditions.

The extrusion system was a tandem extrusion line including a 3½ inch 32:1 L/D single screw primary extruder (Akron Extruders, Canal Fulton, Ohio) and an 8 inch 8:1 L/D single screw secondary extruder (Akron Extruders, Canal Fulton, Ohio) arranged in a right angle configuration. A volumetric feeder capable of supplying up to 30 lb/hr was mounted in the feed throat of the primary extruder such that compounded talc additive pellets could be metered into the primary extruder if desired. An injection system for the injection of blowing agent (e.g., CO₂, N₂, and the like) into the secondary extruder was placed at approximately 8 diameters from the inlet to the secondary extruder. The injection system included 4 equally spaced radially-positioned ports. Each port included 176 orifices, each orifice of 0.02 inch diameter, for a total of 704 orifices. The injection system included an air actuated control valve to precisely meter a mass flow rate of blowing agent at rates from 0.05 to 12 lbs/hr at pressures up to 5500 psi.

The screw of the primary extruder was specially designed screw to provide feeding, melting and mixing of the polymeric material followed by a mixing section for the dispersion blowing agent in the polymer. The outlet of this primary extruder was connected to the inlet of the secondary extruder using a transfer pipe of about 10 inches in length.

The secondary extruder was equipped with specially designed deep channel, multi-flighted screw design to cool the polymer and maintain the pressure profile of the mixture of polymeric material and blowing agent, between injection of blowing agent and entrance to a gear pump (LCI Corporation, Charlotte, N.C.) attached to the exit of the secondary. The gear pump was equipped with an integral jacket for heating/cooling and sized to operate at a maximum output of 500 lb/hr with a rated maximum discharge pressure of 10,000 psi.

The system was equipped, at exit from the gear pump, with a die adapter and a vertically mounted blow molding head (W. Mueller Company, Troisdorf, Germany). The die adapter was equipped with taps for measurement of melt temperature and pressure just prior to entry into the die. The blow molding head included Muller Company's ring divider flow distribution design. The head was equipped appropriate hydraulic controls and a Hunkar control system to provide parison programming capability.

The standard press and molding functions of the Battenfeld-Fischer VK1-5 were maintained in the modified machine. A second regulator and solenoid valve, controlled by an additional timer included in the main machine control program, were added to the blow air system. This added control equipment provided the capability to use different, preset blow pressures of varying duration during the blow cycle.

A standard round bottle mold of approximately 2¼″ OD×8″ tall was mounted in the press.

### EXAMPLE 2

### Bottle Formation—Conventional Single Blow Pressure

This example illustrates the production of blow molded bottles using a conventional single blow pressure blow molding process.

High density polyethylene (Equistar LR 7320) pellets were introduced into the main hopper of the extrusion line described in Example 1 and a pre-compounded talc concentrate (30% talc in a HDPE base) was introduced in the additive feeder hopper. The tooling attached to the blow molding head included a die with a 0.825 exit diameter and 4° taper angle, and a tip of 0.795 exit diameter and 5° taper angle.

The extruder and gear pump rpm were adjusted to provide an output of approximately 300 lb/hr at speeds of approximately 62 rpm on the primary, 8 rpm on the secondary and 16 rpm of the gear pump. Secondary barrel temperatures were set to maintain a melt temperature of approximately 330° F. at entrance to the die. The additive feeder was set to provide an output of approximately 15 lb/hr resulting in a 5.0% by polymer weight talc in the material. N₂ blowing agent was injected at a nominal rate of 0.15 lb/hr, resulting in a mixture having 0.05% weight percentage of blowing agent.

A continuous parison was extruded using the above conditions and sample bottles were blow molded at blow pressures of 70, 50, 30, and 20 psi. All bottles were molded using a blow cycle time of 30 seconds to ensure that bottles were fully cooled prior to removal from the mold. Prior to bottle molding, the parison was cut and the press motions were timed to capture the parison in the mold at the needed length. During bottle molding, the continuous parison was removed from the machine. Bottle wall densities were measured using a Mettler Toledo density balance (Model AG104). The bottle wall densities at different blow pressures are shown in Table 1.

TABLE 1
Blow Pressure and Wall Density of Blow molded Bottles

| Blow Pressure | Wall Density |
|---|---|
| (psi) | (g/cm³) |
| 70 | 0.94 |
| 50 | 0.91 |
| 30 | 0.87 |
| 20 | 0.81 |

At 20 psi blow pressure, bottles could not be consistently formed. At 30 psi blow pressures, there was a loss of sharpness at the transition from the body to neck area as well as a slight bulging in the neck. At blow pressures of 50 psi and 70 psi, high quality blow molded bottles were produced. The wall density increased with increasing blow pressure. The blow molded bottles were formed of microcellular material having an average cell size of about 80 microns.

The example illustrates that high quality bottles could not be formed at a wall density of less than 0.90 g/cm³ using a conventional single blow pressure blow molding process.

### EXAMPLE 3

### Bottle Formation—Variable Blow Pressure

This example illustrates the production of blow molded bottles using a variable blow pressure process according to one embodiment of the present invention.

Bottles were formed using the system of Example 1 and the parison formation conditions of Example 2 except that a variable blow air was utilized. The blow air was programmed to vary pressure during the blow cycle. The total blow cycle time was held constant at 30 seconds. The pressure was varied during the blow cycle from an initial pressure to a final pressure. Bottle wall densities were measured as described in Example 1. The results are summarized in Table 2.

TABLE 2
Blow Pressures and Wall Density of Blow molded Bottles

| Initial Blow | | Final Blow | |
|---|---|---|---|
| Pressure | Initial Blow Time | Pressure | Wall Density |
| (psi) | (sec) | (psi) | (g/cm³) |
| 70 | 0.50 | 10 | 0.80 |
| 70 | 0.50 | 20 | 0.83 |
| 50 | 0.25 | 10 | 0.74 |
| 50 | 0.50 | 10 | 0.78 |
| 50 | 0.25 | 20 | 0.78 |
| 50 | 0.50 | 20 | 0.81 |
| 30 | 0.50 | 10 | 0.74 |
| 30 | 0.50 | 20 | 0.81 |

High quality blow molded bottles having good definition were produced at all conditions. The blow molded bottles were formed of microcellular material having an average cell size of about 80 microns.

The results indicate that varying the blow pressure enabled production of high quality blow molded bottles at relatively low densities (0.83 g/cm³ and lower). In particular, a blow cycle including a short duration, initial high pressure blow followed by a longer, low final pressure blow was found to be effective. The densities achieved with the varying blow pressure were lower than the densities achieved with the single blow pressure in Example 2.

### EXAMPLE 4

### Bottle Formation—Variable Blow Pressure

This example illustrates the production of blow molded bottles using a variable blow pressure process according to one embodiment of the present invention.

Bottles were formed using the system of Example 1 and the parison formation conditions of Example 3, except that Equistar LP 5403 high density polyethylene was used (instead of the LP 7320 which was used in Example 3). Bottle wall densities were measured as described in Example 1. The results are summarized in Table 3.

TABLE 3
Blow Pressures and Wall Density of Blow molded Bottles

| Initial Blow | | Final Blow | |
|---|---|---|---|
| Pressure | Initial Blow Time | Pressure | Wall Density |
| (psi) | (sec) | (psi) | (g/cm³) |
| 50 | 0.25 | 20 | 0.84 |
| 50 | 0.25 | 10 | 0.78 |
| 30 | 0.25 | 10 | 0.74 |

High quality blow molded bottles having good definition were produced at all conditions. The blow molded bottles were formed of microcellular material having an average cell size of about 80 microns.

The results indicate that varying the blow pressure enabled production of high quality blow molded bottles at relatively low densities using a different material than in Example 3. The densities achieved with the varying blow pressure were lower than the densities achieved with the single blow pressure in Example 2.

### EXAMPLE 5

### Bottle Formation—Variable Blow Pressure

This example illustrates the production of blow molded bottles using a different material than Examples 3 and 4 and different variable blow pressure conditions.

Bottles were formed using the system of Example 1 and the parison formation conditions of Example 3, except that a pre-compounded calcium carbonate concentrate (50% CaCO₃ in a HDPE base) was used instead of talc and a three-stage blow pressure process was used.

The additive feeder was set to provide an output of approximately 36 lb/hr resulting in a 12% by polymer weight CaCO₃ in the material. Additionally, a third blow pressure capability was added to the system. A blow pressure profile that contained 1) a short duration, high pressure blow followed by 2) longer low pressure blow, followed by a 3) longer duration, high blow pressure was used to produce bottles. Bottle wall densities were measured as described in Example 1. The results are summarized in Table 4 and illustrated visually in the photographs of FIG. 3.

TABLE 4
Bottle Formation - Variable Blow Pressure

| Initial Blow | Intermediate Blow | Final Blow | |
|---|---|---|---|
| Pressure/Time | Pressure/Time | Pressure/Time | Wall Density |
| (psi/sec) | (psi/sec) | (psi/sec) | (g/cm³) |
| 30/0.25 | 10/30 | — | 0.740 |
| 30/0.25 | 10/8 | 30/22 | 0.743 |
| 30/0.25 | 10/8 | 50/22 | 0.744 |
| 30/0.25 | 10/8 | 60/22 | 0.744 |
| 30/0.25 | 10/4 | 30/26 | 0.775 |
| 30/0.25 | 10/4 | 50/26 | 0.802 |
| 30/0.25 | 10/4 | 60/26 | 0.804 |
| 30/0.25 | 10/2 | 30/28 | 0.803 |
| 30/0.25 | 10/2 | 50/28 | 0.830 |
| 30/0.25 | 10/2 | 60/28 | 0.858 |
| 30/0.25 | 10/1 | 30/29 | 0.827 |
| 30/0.25 | 10/1 | 50/29 | 0.858 |
| 30/0.25 | 10/1 | 60/29 | 0.876 |

High quality blow molded bottles having good definition were produced at all conditions. Definition improved with increasing final blow pressure and final blow pressure time. The blow molded bottles were formed of microcellular material having an average cell size of about 80 microns.

The results indicate that varying the blow pressure enabled production of high quality blow molded bottles at relatively low densities with excellent definition. The use of a three pressure stage blow pressure provided improved bottle definition at equal product density as compared to previous examples.

Those skilled in the art would readily appreciate that all parameters listed herein are meant to be exemplary and that actual parameters will depend upon the specific application for which the blow molding systems and methods of the present invention are used. For example, using the blow molding systems and methods of the present invention the density and definition of the blow molded article may be optimized depending the specific requirements of the article. It is, therefore, to be understood that the foregoing embodiments are presented by way of example only and that, within the scope of the appended claims and equivalents thereto, the invention may be practiced otherwise than as specifically described.

What is claimed is:

1. A method of blow molding comprising:
blow molding a foam parison using variable pressure.

2. The method of claim 1, comprising blow molding a foam parison using a pressure within a first pressure range, followed by a pressure within a second pressure range.

3. The method of claim 2, wherein the first pressure range is greater than the second pressure range.

4. The method of claim 2, wherein the first pressure range is greater than about 25 psi.

5. The method of claim 2, wherein the first pressure range is greater than about 50 psi.

6. The method of claim 2, wherein the first pressure range is greater than about 75 psi.

7. The method of claim 2, wherein the variable pressure is applied over a blow cycle and the pressure within the first pressure range is applied for a time period of less than 25 percent of the time period of the blow cycle.

8. The method of claim 2, wherein the second pressure range is less than about 50 psi.

9. The method of claim 2, wherein the second pressure range is less than about 20 psi.

10. The method of claim 2, wherein the second pressure range is between about 10 psi and about 20 psi.

11. The method of claim 2, wherein the variable pressure is applied over a blow cycle and the pressure within the second pressure range is applied for a time period of greater than 25 percent of the time period of the blow cycle.

12. The method of claim 2, further comprising blow molding the foam parison using a pressure within a third pressure range following the pressure within the second pressure range.

13. The method of claim 12, wherein the third pressure range is greater than the second pressure range.

14. The method of claim 12, wherein the third pressure range is greater than 40 psi.

15. The method of claim 12, wherein the variable pressure is applied over a blow cycle and the pressure within the third pressure range is applied for a time period of greater than 25 percent of the time period of the blow cycle.

16. The method of claim 1, wherein the variable pressure is greater than 40 psi for at least a portion of the blow molding cycle.

17. The method of claim 1, comprising positioning the foam parison in a blow mold and introducing gas at a variable pressure into the foam parison to blow mold the foam parison.

18. The method of claim 1, comprising positioning the foam parison in a blow mold and evacuating the mold at a variable pressure to blow mold the foam parison.

19. The method of claim 1, further comprising forming a blow molded article.

20. The method of claim 19, wherein the article comprises microcellular material having an average cell size of less than 100 microns.

21. The method of claim 19, wherein the article comprises microcellular material having an average cell size of less than 50 microns.

22. The method of claim 19, wherein the article comprises a polymeric foam having a void fraction of greater than 0.05.

23. The method of claim 19, wherein the article comprises a polymeric foam having a void fraction of greater than 0.20.

24. The method of claim 19, wherein the article comprises a polymeric foam having a void fraction of greater than 0.35.

25. A method of blow molding comprising:
positioning a foam parison in a mold;
introducing a gas into the foam parison in the mold at a first pressure; and
changing the pressure of the gas introduced into the parison to a second pressure greater than atmospheric pressure.

26. The method of claim 25, further comprising forming a microcellular article from the foam parison having an average cell size of less than 100 microns.

27. A method of blow molding comprising:
blow molding a polymeric parison using a pressure within a first pressure range, followed by a pressure within a second pressure range, followed by a pressure within a third pressure range.

28. The method of claim 27, wherein the first pressure range is greater than the second pressure range.

29. The method of claim 27, wherein the first pressure range is greater than about 25 psi.

30. The method of claim 27, wherein the first pressure range is greater than about 50 psi.

31. The method of claim 27, wherein the first pressure range is greater than about 75 psi.

32. The method of claim 27, wherein the first pressure range is between about 40 psi and about 80 psi.

33. The method of claim 27, wherein the variable pressure is applied over a blow cycle and the pressure within the first pressure range is applied for a time period of less than 25 percent of the time period of the blow cycle

34. The method of claim 27, wherein the second pressure range is less than about 50 psi.

35. The method of claim 27, wherein the second pressure range is less than about 20 psi.

36. The method of claim 27, wherein the second pressure range is between about 10 psi and about 20 psi.

37. The method of claim 27, wherein the variable pressure is applied over a blow cycle and the pressure within the second pressure range is applied for a time period of greater than 25 percent of the time period of the blow cycle.

38. The method of claim 27, wherein the third pressure range is greater than the second pressure range.

39. The method of claim 27, wherein the third pressure range is greater than 40 psi.

40. The method of claim 27, wherein the variable pressure is applied over a blow cycle and the pressure within the third pressure range is applied for a time period of greater than 25 percent of the time period of the blow cycle.

41. The method of claim 27, wherein at least one of the pressures is greater than 40 psi.

42. The method of claim 27, comprising positioning the polymeric parison in a blow mold and introducing gas into the parison at a pressure within a first pressure range, followed by gas at a pressure within a second pressure range, followed by gas at a pressure within a third pressure range to blow mold the parison.

43. The method of claim 27, comprising positioning the polymeric parison in a blow mold and evacuating the mold at a pressure within a first pressure range, followed by evacuating the mold at a pressure within a second pressure range, followed by evacuating the mold at a pressure within a third pressure range to blow mold the parison.

44. The method of claim 27, wherein the polymeric parison comprises a solid polymeric material.

45. The method of claim 27, wherein the polymeric parison comprises a polymeric foam.

46. The method of claim 27, further comprising forming a blow molded article.

47. The method of claim 46, wherein the article comprises a microcellular material having an average cell size of less than 100 microns.

48. The method of claim 46, wherein the article comprises a microcellular material having an average cell size of less than 50 microns.

49. The method of claim 46, wherein the article comprises a polymeric foam having a void fraction of greater than 0.05.

50. The method of claim 46, wherein the article comprises a polymeric foam having a void fraction of greater than 0.35.

51. A blow molding system comprising:
a polymer processing apparatus constructed and arranged to release polymeric material through an outlet of the polymer processing apparatus to form a parison;
a mold positioned to receive the parison;
a pressure supply associated with the mold and capable of providing a variable blow pressure to the parison in the mold; and
a controller coupled to the pressure supply and designed to control the pressure provided by the pressure supply.

52. The blow molding system of claim 51, wherein the polymer processing apparatus comprises an extruder including a barrel and a screw mounted therein.

53. The blow molding system of claim 51, wherein the extruder includes a die mounted to a downstream end of the barrel.

54. The blow molding system of claim 52, wherein the extruder includes a blowing agent port formed in the barrel and connectable to a blowing agent source to provide a pathway for blowing agent to flow from the source to polymeric material in the barrel.

55. The blow molding system of claim 51, wherein the pressure supply introduces gas into the foam parison to provide the pressure.

56. The blow molding system of claim 51, wherein the pressure supply evacuates the atmosphere within the mold external of the foam parison to provide the pressure.

57. The blow molding system of claim 51, wherein the controller is designed to control the pressure provided by the pressure supply to a pressure within a first pressure range, followed by a pressure within a second pressure range.

58. The blow molding system of claim 57, wherein the controller is designed to control the pressure provided by the pressure supply to a pressure within a first pressure range, followed by a pressure within a second pressure range, followed by a pressure within a third pressure range.
